(19) United States
(12) Patent Application Publication
(10) Pub. No.: US 2005/0141722 A1
(43) Pub. Date: Jun. 30, 2005

(54) Signal processing

(75) Inventors: Leon Maria Van De Kerkhof, Eindhoven (NL); Fransiscus Marinus Jozephus De Bont, Eindhoven (NL); Arnoldus Werner Johannes Oomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/509,476

(22) PCT Filed: Mar. 19, 2003
(86) PCT No.: PCT/IB03/00988

(30) Foreign Application Priority Data
Apr. 5, 2002 (EP) 02076345.4

(51) Int. Cl. H04R 5/00

(52) U.S. Cl. 381/23

(57) ABSTRACT

Sum/difference coding of a compatible signal, typically in case of a dominant centre signal or dominant surround situation of a multi-channel audio stream to be decoded by both a stereo decoder and by a multi-channel decoder, to provide improved encoding of multiple input signals employing compatibility matrixing.

### FIELD OF THE INVENTION

The present invention relates to processing of information signals and, more particularly to processing of audio signals.

### BACKGROUND OF THE INVENTION

The introduction of new systems like DVB and DVD has brought digital multi-channel sound within reach of a large group of users. The majority of users will however stay for a long time with stereo sound reproduction.

One solution to both serve consumers with 2-channel equipment and multi-channel equipment is so-called simulcast. In this case, two separate information signals are transmitted in parallel, one containing a representation of the multi-channel sound and one containing a representation of the 2-channel sound. To achieve an economical use of transmission or storage capacity, audio bit rate reduction will be used in most applications. The transmitted or stored information signal will then be in the form of a coded bit stream, which requires a decoder to retrieve the audio signal to be reproduced. Nevertheless, it is obvious that simulcast is an expensive solution in terms of required transmission or storage capacity. This makes this solution unacceptable in most practical situations.

Another solution is to transmit only the multi-channel information signal, directly serving the consumers with multi-channel sound reproduction equipment. The 2-channel users then need a decoder that consists of a multi-channel decoder, followed by a downmix module that creates a downmix from multi-channel to 2-channel. Such a 2-channel decoder is thus more complex than a regular multi-channel decoder. In this case, the 2-channel users (the majority) have to pay for the multi-channel capability of others.

It is undesirable that those users are burdened by the multi-channel audio capabilities of a system, in the form of higher costs or higher power consumption. It is also undesirable to waste bandwidth of the system by simulcast (storage and transmission of both a 2-channel (stereo) and a multi-channel stream).

An encoding system that allows a single coded multi-channel audio stream to be decoded by both a true stereo decoder and a multi-channel decoder is the MPEG-2 audio backwards compatible multi-channel coder (MPEG-2 BC). In all other coding systems, the stereo decoder is basically a (an expensive) multi-channel decoder followed by a down-mix to stereo.

The MPEG-2 BC coder achieves this by performing at the encoder side a down-mix from e.g. 5 channel sound to stereo, coding this as a pure stereo stream, and encoding as an extension three properly chosen signals out of the five input signals. The stereo decoder only decodes the pure stereo stream. A multi-channel decoder also decodes the extra information, and uses an inverse matrix to retrieve the original 5 channels from the down-mix and the additional three channels. This inverse matrix is encoded as side information in the coded bitstream.

U.S. Pat. No. 6,275,589 B1 describes MPEG-2 having backwards compatibility with MPEG-1, whereby the signals of multi-channel sound channels are matrixed. Stereo signals calculated in a process are then transmitted as an MPEG-1-compatible stereo signal and remaining audio signals are transmitted as supplementary data. This method is known as “compatibility matrixing”.

In “Compatibility Matrixing of Multi-Channel Bit Rate Reduced Audio Signals” by ten Kate, preprint 3792, 96^{th} ABS Convention, 1994, Feb. 26-Mar. 01, Amsterdam, it is recognised that the MPEG-2 BC system is not working in an optimal way in case one of the signals in the multi-channel configuration is down-mixed to both the left and right channel of the stereo downmix. This is specifically the case for the Centre channel or for a monophonic Surround channel. The first situation is commonly referred to as the “Dominant Centre” situation.

### SUMMARY OF THE INVENTION

It is an object of the invention to provide improved encoding of multiple input signals employing compatibility matrixing. To this end, the invention provides a method for encoding, a method for decoding, an apparatus for encoding, an apparatus for decoding, a signal format and a record carrier as defined in the independent claims. Advantageous embodiments are defined in the independent claims.

According to a first aspect of the invention, the object is realized by encoding N input signals, with N>2, said encoding comprising:
generating from the N input signals a composition of M signals, with N>M≧2,
encoding the composition of M signals into coded data,
encoding a selection of N-M out of the N input signals into coded data,
   wherein the composition of M signals is orthogonalized prior to encoding.

Preferably, orthogonalization is done by switching between independent coding and sum/difference coding. For example, sum/difference signal coding of the compatible signal, i.e. the composition of M signals, is used in case of a dominant center situation or a dominant surround situation, and independent coding is used in other situations.

In an embodiment of the invention, the encoder includes a control signal in the encoded signal to indicate to the decoder how the orthogonalizing has been performed and consequently how the de-orthogonalizing should be performed.

Preferably, M=2.

Preferably, orthogonalization is done in the frequency domain.

Preferably, switching between independent coding and sum/difference coding can be selected per frequency band.

These and other aspects and embodiments of the invention will be apparent from the preferred embodiments(s) described hereinafter.

### BRIEF DESCRIPTION OF THE DRAWINGS

The present invention will be more clearly understood from the following description of the preferred embodiments of the invention read in conjunction with the attached drawings, in which:

FIG. 1 illustrates a block diagram of a system in which the present invention is implemented;

FIG. 2 illustrates a signal going out from an encoder, and

FIG. 3 illustrates a flow diagram for a method according to a preferred embodiment of the invention.

### DETAILED DESCRIPTION OF THE INVENTION

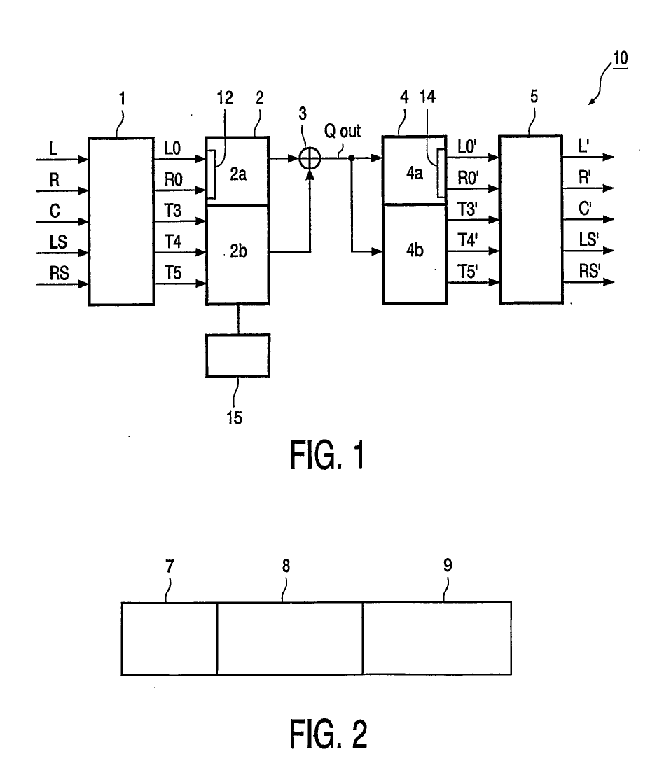

FIG. 1 illustrates an overall block diagram of a system 10 in which the present invention is implemented. The system 10 comprises a matrix 1 including downmixing and selection of N-M signals from the N input signals, an encoder 2 including a stereo encoder 2a and a surround extension encoder 2b, a multiplexer/formatter unit 3, a decoder 4, including a stereo decoder 4a and a surround extension decoder 4b, an inverse matrix 5 and switching unit 15 for switching the coding carried out in the encoder 2a between at least two coding modes. The system 10 illustrated in FIG. 1 shows a multi-channel encoder/multi-channel decoder system having down-mix in the encoder.

N input channels, e.g. a left channel L, a right channel R, a centre signal C, a left surround signal LS, and a right surround signal RS are first transmitted to the matrix 1 and further to the encoder 2 comprising the stereo encoder 2a and a surround encoder 2b. The stereo encoder 2a encodes a composition of M=2 signals, e.g. L0=L+C+LS and R0=R+C+RS. The stereo encoder 2a further comprises an orthogonalizing unit 12 which orthogonalizes the composition of the M=2 signals, together with switching unit 15, e.g. by performing a switch to sum/difference coding of L0 and R0 in the case of dominant center or dominant surround. The orthogonalizing unit 12 further provides a control signal to indicate to the decoder how the orthogonalizing has been performed and consequently how the de-orthogonalizing should be performed. The encoding preferably is a so-called “perceptual audio encoding”, whereby each of a succession of time domain blocks of an audio signal is coded in the frequency domain. Specifically, the frequency domain representation of each block is divided into bands, each of which is coded based on psycho-acoustic criteria, so that the audio signal is compressed efficiently. Other types of coding schemes are also possible, but are not further described in this example.

The encoded signal is multiplexed/formatted in the multiplexer/formatter unit 3 and transmitted as a signal Qout to the decoder 4 as a composition of M signals in a first bit-stream and a selection of N-M signals in a second bit-stream (illustrated as two arrows going into the decoder 4). The signal Qout is illustrated in FIG. 2, which illustrates the two bit streams “onto” each other. Each bit-stream comprises a header 7 and data fields 8 and/or 9. The control signal indicating how the orthogonalizing has been performed, may be included in a header 7 of the first and/or the second bitstream.

Alternatively, the coded data representing the orthogonalized composition of M signals and the coded data representing the selection of N-M signals are included in the same bit-stream, e.g. in the data fields 8 and 9 respectively. The control signal, indicating how the orthogonalizing has been performed, may then be included in the header 7.

The decoder 4 comprises a stereo decoder 4a and a surround extension decoder 4b. Matrix 5 derives the original 5 channels from the decoded stereo stream and the additional decoded three channels. Matrix 5 performs an operation which is inverse or substantially inverse to the operation performed in matrix 1. The stereo decoder 4a further comprises a de-orthogonalizing unit 14 which de-orthogonalizes the composition of the M=2 signals, after decoding, e.g. by switching to sum/difference decoding or independent decoding in dependence on the control signal indicating to the decoder how the orthoganilizing has been performed and consequently how the de-orthoganilizing should be performed. This control signal, which originates from unit 12 is included in the coded data stream.

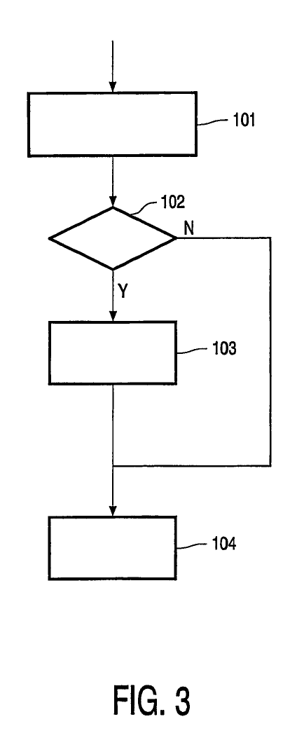

FIG. 3 illustrates a flow diagram of a method according to a preferred embodiment for encoding the N input signals. In a first step 101, the N input signals are transformed to a frequency domain representation prior to encoding. In a second step 102, it is determined whether a dominant center situation or dominant surround situation occurs (indicated Y) or not (indicated N). If Y, then the sum/difference coding mode (step 103) is selected. If N, then the signals are independently coded. The actual coding takes place in step 104. In step 104, the composition of M signals is coded into a bit stream of data, typically a first bit-stream and a selection of N-M out of the N input signals is coded into another bit-stream of data, typically a second bit-stream of data. Steps 102 and 103 together are also referred to as the orthogonalization step.

As is clear to the skilled person, the decoding operation is inverse or substantially inverse to the encoding operation.

Examples of matrix equations will be described below to explain embodiments of the invention better. The matrix equations 1-21 describe a situation where the present invention is not applied. These equations are shown to describe the encoding and decoding before describing the equations of a preferred embodiment of the invention for a better understanding of the invention.

Example matrix equations are the following (gain factors are omitted for clarity):

At the encoder side:

| | |
|---|---|
| L0 = L + C + LS | (1) |
| R0 = R + C + RS | (2) |
| T3 = C | (3) |
| T4 = LS | (4) |
| T5 = RS | (5) |

where the transmission channels are: L0, R0, T3, T4 and T5.

At the decoder side:

| | |
|---|---|
| C′ = T3′ | (6) |
| LS′ = T4′ | (7) |
| RS′ = T5′ | (8) |
| L′ = L0′ − C′ − LS′ = L0′ − T3′ − T4′ | (9) |
| R′ = R0′ − C′ − RS′ = R0′ − T3′ − T5′ | (10) |

where the sign ′ denotes a decoded signal.

Although the matrix inversion at the decoder side is exact, the equations above do not yield exactly the original input signals, because the transmission channels L0, R0, T3, T4 and T5 are altered by the encoding.

The coding of T3, T4 and T5 is directly controlled by the perceptual encoder and consequently C′, LS′ and RS′ will not give rise to quality problems. In the example presented above, due to the matrixing, the coding noise in L0, T3 and T4 will appear in L′, and the coding noise in R0, T3 and T5 will appear in R′. This coding noise could be minimized by choosing appropriate extra channels to be transmitted with L0 and R0. If C, LS and RS are the weakest signals, then the coding noise in L′ and R′ will be dominated by L0′ and R0′, respectively, which is again directly controlled by the perceptual encoder. If another signal combination is the weakest, this signal combination should be chosen to be transmitted as T3, T4 and T5.

However, when the center signal C is the strongest signal (in the following referred to as the “dominant center” situation), L0 is almost equal to R0.

It can be shown that one of the small signals always needs to be retrieved by subtracting two large almost equal signals to obtain a small signal. This can be represented by the following formulas:

At the encoder side:

| | |
|---|---|
| L0 = L + C + LS | (11) |
| R0 = R + C + RS | (12) |
| T3 = L | (13) |
| T4 = LS | (14) |
| T5 = RS | (15) |

At the decoder side:

| | |
|---|---|
| L′ = T3′ | (16) |
| LS′ = T4′ | (17) |
| RS′ = T5′ | (18) |
| C′ = L0′ − L′ − LS′ = L0′ − T3′ − T4′ | (19) |
| R′ = R0′ − C′ − RS′ = R0′ − C′ − T5′ | (20) |
| = R0′ − L0′ + T3′ + T4′ − T5′ | (21) |

where R′ is small, R0′ and L0′ are both large and T3′, T4′ and T5′ are all small. It is clear that a relatively small error in L0 or R0 will lead to a relatively large and clearly audible error in the resulting signal R′. The quality could be maintained; but only by coding at least one of the compatible signals L0, R0 at a much higher bit-rate than is necessary for good sound quality of that signal on itself. Another way could be to code additional transmission channels, in this case for instance four, but this is typically a waste of bandwidth as well. Therefore, according to an aspect of the invention, there is provided an encoder for sum/difference coding of the compatible signal in case of a dominant center situation. In this way, the center signal C falls out of one of the equations for the compatible signal, and that equation can be used to calculate a fourth small signal. Of course, for a non-dominant situation, everything can remain the same. For a dominant situation, a matrixing of the compatible signal is added:

At the encoder side:

| | |
|---|---|
| L0 = L + C + LS | (22) |
| R0 = R + C + RS | (23) |
| T3 = L | (24) |
| T4 = LS | (25) |
| T5 = RS | (26) |
| Ch0 = L0 + R0 = L + R + 2C + LS + RS | (27) |
| Ch1 = L0 − R0 = L − R + LS − RS | (28) |

At the decoder side:

| | |
|---|---|
| L′ = T3′ | (29) |
| LS′ = T4′ | (30) |
| RS′ = T5′ | (31) |
| R′ = L′ + LS′ − RS′ − Ch1′ = T3′ + T4′ − T5′ − Ch1′ | (32) |
| 2C′ = Ch0′ − L′ − R′ − LS′ − RS′ = Ch0′ + Ch1′ − 2T3′ − 2T4′ | (33) |

Now R′ can be obtained from small signals only, C′ from one strong signal (Ch0′) plus a number of small signals. The situation wherein strong signals are subtracted from each other to obtain a small signal is avoided in this way. In the compatible stereo decoder 4a, the following matrix has to be performed:

| | |
|---|---|
| L0 = (Ch0 + Ch1)/2 | (34) |
| R0 = (Ch0 − Ch1)/2 | (35) |

Another situation where the invention finds application is when the compatible signal (L0, R0) includes a matrixed surround signal, i.e. monophonic surround (S=f(LS+RS)) in the downmix and when S is the strongest signal. This is referred to as a so-called “dominant surround situation”. In this situation, L0 is in amplitude almost equal to R0 but in anti-phase. Selecting the left channel L, the right channel R and the centre signal C for transmission in the T3, T4 and T5 makes it impossible to retrieve LS and RS with an inverse matrix. It can be shown that always one of the small signals needs to be retrieved by adding L0′ and R0′. The weakest of LS and RS should be selected as the third additional signal. This is illustrated in an example below:

At the encoder side:

| | |
|---|---|
| L0 = L + C − LS − RS | (36) |
| R0 = R + C + LS + RS | (37) |
| T3 = C | (38) |
| T4 = L | (39) |
| T5 = RS | (40) |

At the decoder side:

| | |
|---|---|
| C′ = T3′ | (41) |
| L′ = T4′ | (42) |
| RS′ = T5′ | (43) |
| LS′ = L′ + C′ − L0′ − RS′ = T4′ + T3′ − L0′ − T5 | (44) |
| R′ = R0′ − C′ − LS′ − RS′ = R0′ − T3′ − LS′ − T5′ | (45) |

Due to the fact that L0′ and R0′ are in anti-phase this means adding two large almost equal signals to obtain a small signal R′. It is clear that a relatively small error in L0′ or R0′ will lead to a relatively large and clearly audible error in the resulting signal. The quality can still be maintained, but only by coding at least one of the compatible signals with a much higher bit-rate than necessary for good sound quality of that signal on itself. Also in this case could another way be to code additional transmission channels at the cost of waste of bandwidth.

According to another preferred embodiment of the invention, a matrixing of the compatible signal is added according to the following equations:

At the encoder side:

| | |
|---|---|
| L0 = L + C − LS − RS | (46) |
| R0 = R + C + LS + RS | (47) |
| T3 = C | (48) |
| T4 = L | (49) |
| T5 = RS | (50) |
| Ch0 = L0 + R0 = L + R + 2C | (51) |
| Ch1 = L0 − R0 = L − R − 2LS − 2RS | (52) |

At the decoder side:

| | |
|---|---|
| C′ = T3′ | (53) |
| L′ = T4′ | (54) |
| RS′ = T5′ | (55) |
| R′ = Ch0′ − L′ − 2C′ = Ch0′ − T4′ − 2T3′ | (56) |
| 2LS′ = L′ − R′ − 2RS′ − Ch1′ = T4′ − R′ − 2T5′ − Ch1′ | (57) |

Now R′ is obtained from only small signals, LS′ from one strong signal (Ch1′) plus a number of small signals. The situation that strong signals are subtracted from each other to obtain a small signal is avoided in this way. In the compatible stereo decoder, the following matrix has to be performed:

| | |
|---|---|
| Lo = (Ch0 + Ch1)/2 | (58) |
| Ro = (Ch0 − Ch1)/2 | (59) |

The invention finds application for instance in multi-channel music distribution.

The coded data can be stored and subsequently read, decoded and presented to a listener of a record carrier.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for encoding N input signals, with N>2, said method comprising the steps of:
generating from the N input signals a composition of M signals, with N>M≧2,
encoding the composition of M signals into coded data,
encoding a selection of N-M out of the N input signals into coded data,
wherein the composition of M signals is orthogonalized prior to encoding.

2. A method according to claim 1, wherein the orthogonalizing is done by switching between sum/difference coding and independent coding.

3. A method according to claim 1, wherein a control signal is included in the coded data to indicate to the decoder how the orthogonalizing has been performed.

4. A method according to claim 1, wherein the composition of M signals is coded into a first bit-stream, and the selection of N-M signals is coded into a second bit-stream.

5. A method according to claim 1, wherein M=2.

6. A method according to claim 1, wherein the N input signals are transformed to a frequency domain prior to encoding.

7. A method according to claim 1, wherein the orthogonalization is performed per frequency band.

8. A method for decoding coded data representative of N signals, the coded data comprising a composition of M signals and a set of N-M signals, with N>M≧2, and wherein said composition of M signals is orthogonalized, the method for decoding comprising:
decoding the coded data to obtain the composition of M signals and the set of N-M signals,
generating a set of N output signals from the composition of M signals and the set of N-M signals,
wherein the composition of M signals is de-orthogonalized prior to the generation of N output signals.

9. A method for decoding as claimed in claim 8, wherein the de-orthogonalizing is done by switching between sum/difference decoding and independent decoding.

10. Apparatus for encoding N input signals, with N>2, said apparatus comprising means for:
generating from the N input signals a composition of M signals, with N>M≧2,
encoding the composition of M signals into coded data,
encoding a selection of N-M out of the N input signals into coded data,
orthogonalizing the composition of M signals prior to encoding.

11. An apparatus for decoding coded data representative of N signals, the coded data comprising a composition of M signals and a set of N-M signals, with N>M≧2, and wherein said composition of M signals is orthogonalized, the apparatus for decoding comprising:
decoding the coded data to obtain the composition of M signals and the set of N-M signals,
generating a set of N output signals from the composition of M signals and the set of N-M signals,
wherein the composition of M signals is de-orthogonalized prior to the generation of N output signals.

12. A signal format for use in transmitting coded data representative of N signals, the coded data comprising a composition of M signals and a set of N-M signals, with N>M≧2, and wherein said composition of M signals is orthogonalized.

13. A signal format as claimed in claim 12, wherein a control signal is included in the coded data to indicate to the decoder how the orthogonalizing has been performed.

14. A record carrier on which a signal format as claimed in claim 12 has been stored.
